(19) United States
(12) Patent Application Publication
(10) Pub. No.: US 2013/0061488 A1
(43) Pub. Date: Mar. 14, 2013

(54) Heating Circuit With Monitoring Arrangement for a Household Appliance

(71) Applicants: Marco Lorenzi, Porcia (PN) (IT); Paolo Driussi, Zoppola (PN) (IT)

(72) Inventors: Marco Lorenzi, Porcia (PN) (IT); Paolo Driussi, Zoppola (PN) (IT)

(73) Assignee: ELECTROLUX HOME PRODUCTS CORPORATION N.V., Brussel (BE)

(21) Appl. No.: 13/697,838

(22) PCT Filed: May 12, 2011
(86) PCT No.: PCT/EP11/57712

§ 371 Date: Nov. 14, 2012

(30) Foreign Application Priority Data
May 14, 2010 (EP) 10162838.6

(51) Int. Cl. H05B 1/02; B08B 3/10; F26B 23/04; D06F 33/02

(52) U.S. Cl. 34/89; 134/58 R

(57) ABSTRACT

A washing and/or drying appliance includes a heating circuit (140) for heating a washing liquid and/or a drying air flow, connected to voltage distribution lines (105a,105b) distributing power inside the appliance. The heating circuit includes at least one heating resistor (205) in series to switch means (210a,210b) controlled by an appliance control unit (125) for selectively energizing the heating resistor when required. The switch means of the heating circuit includes a first and a second switch (210a,210b) in series to the heating resistor, the heating resistor being interposed between the first and second switches. A monitoring circuit arrangement is provided, which includes a first resistor (R1) in shunt to the heating resistor and having a resistance substantially higher than that of the heating resistor, and a pull-up network connected between a first terminal (215b;215a) of the heating resistor and one of the voltage distribution lines. The control unit is configured for receiving a voltage corresponding to an electric potential at a second terminal (215a;215b) of the heating resistor.

The present invention relates in general to the field of household appliances, and more particularly to a heating circuit with monitoring arrangement for appliances like laundry washers, combined washers&dryers, dryers, dishwashers and the like, and in general for all those appliances wherein there is the necessity of heating a fluid (a washing liquid like in laundry washing machines or in dishwashers, or drying air like in laundry dryers).

Heating circuits for household appliances like those listed above generally comprise a heating element consisting of a heating resistor and a switch element (e.g. a relay commanded by an appliance control unit or a level switch which closes only when a sufficient amount of liquid is present in the washing tub to ensure that the heating resistor is immersed) for energizing the heating resistor when required, for example in order to heat the washing liquid for washing laundry or dishes, or to heat the air flow used to dry the laundry.

The heating circuit is generally monitored for assessing the proper operation and detecting possible faults thereof. Faults may as a matter of fact occur in the heating resistor or in the switch element energizing it. Usually, the heating circuit is monitored to identify whether the heating resistor is power on or off, or it is short-circuited to earth. Some of these faults may be extremely dangerous, for the appliance and even more for the user. For example, overheating of the heating resistor should be prevented, not to cause component parts to be damaged or destroyed, and fires to be produced; also, a heating resistor that occurs to be short-circuit to earth is a source of danger, because dispersion currents may reach the appliance cabinet and cause electrical shocks to the user. In case a fault of this type is detected, a decision is to be taken to halt the appliance.

The Applicant has observed that known monitoring arrangements of the heating circuit are not capable of discriminating among different types of faults. Some faults may be classified as dangerous for the user's safety and thus lead to the appliance halt even if, actually, there would be no risk and the machine operation could be continued. This is undesirable, because the user has to wait for the intervention of the service personnel.

In view of the state of the art outlined above, it has been an object of the present invention to devise an improved heating circuit arrangement for a household appliance that guarantees a full monitoring and discrimination of essentially every possible fault.

According to the present invention, there is provided washing and/or drying appliance, comprising a heating circuit for heating a washing liquid and/or a drying air flow, the heating circuit being connected to (AC) voltage distribution lines distributing (AC) power inside the appliance and comprising at least one heating resistor in series to switch means controlled by an appliance control unit for selectively energizing the heating resistor when required.

The switch means of the heating circuit comprise a first and a second switches in series to the heating resistor, the heating resistor being interposed between the first and second switches.

A monitoring circuit arrangement is provided, comprising a first resistor in shunt to the heating resistor and having a resistance substantially higher than that of the heating resistor, and a pull-up network connected between a first terminal of the heating resistor and one of the voltage distribution lines, the control unit being configured for receiving a voltage corresponding to an electric potential at a second terminal of the heating resistor.

The appliance may further comprise a main switch controlled by the control unit for selectively allowing the powering of the appliance, and the heating circuit may be connected to the voltage supply lines upstream or downstream the main switch with respect to an AC voltage plug of the appliance.

The main switch may be a switch switchable to close only conditioned to the fact that the control unit detects that an appliance door is closed.

The pull-up network may be connected to the voltage distribution lines either downstream or upstream the main switch.

The monitoring unit may further be configured for detecting a value of the voltage distributed by the voltage distribution lines and for comparing the detected value of the voltage distributed by the voltage distribution lines with the received voltage corresponding to the electric potential at the second terminal of the heating resistor.

In particular, the monitoring unit may be configured for dynamically deriving, during the operation of the appliance, from the detected value of the voltage distributed by the voltage distribution lines at least one reference electric potential to be compared with the received voltage corresponding to the electric potential at the second terminal of the heating resistor.

Said reference electric potential derived in dynamic way is preferably calculated periodically.

These and other features and advantages of the present invention will appear more clearly by reading the following detailed description of an embodiment thereof, provided merely by way of non-limiting example, description that will be conducted making reference, for better intelligibility, to the attached drawings, wherein:

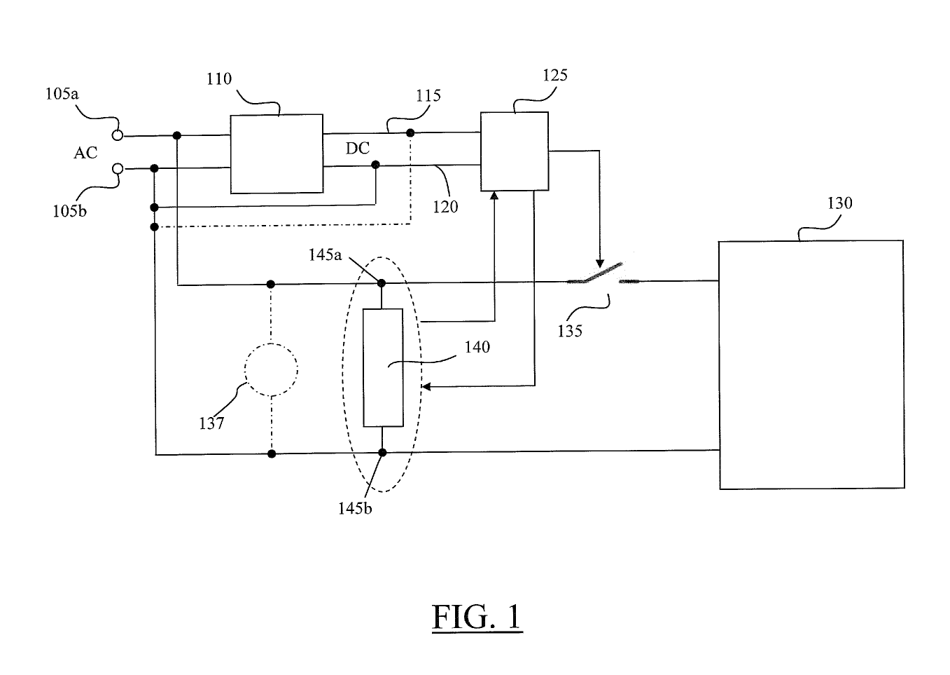

FIG. 1 is a schematic block diagram of part of an electric circuitry of a household appliance, for example a laundry washer, with a heating circuit arrangement according to an embodiment of the present invention; and

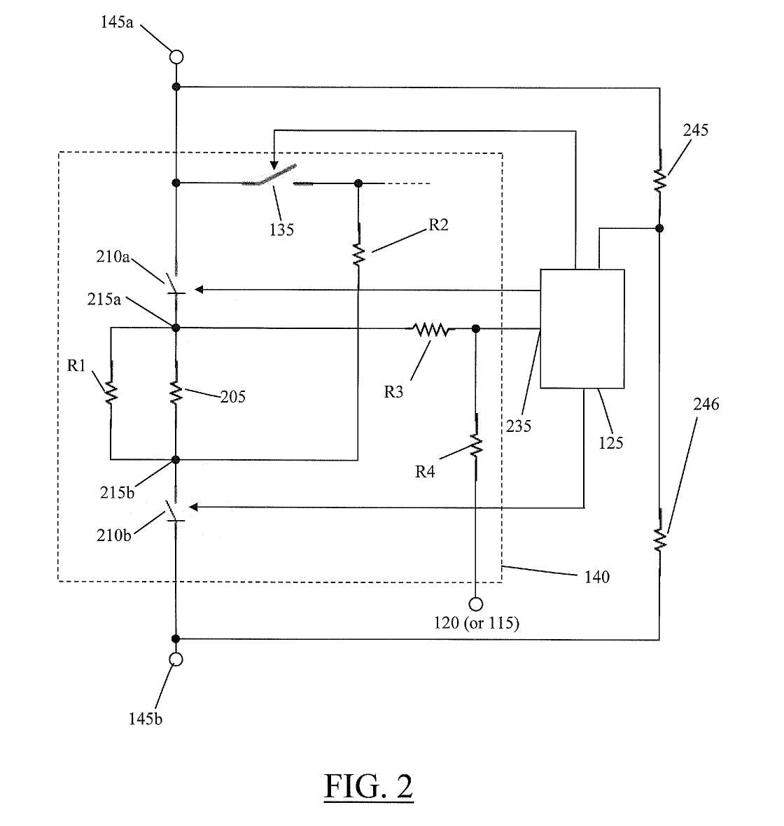

FIG. 2 shows in greater detail the heating circuit arrangement of FIG. 1.

Making reference to the drawings, FIG. 1 depicts a schematic block diagram of part of an electric circuitry of a household appliance, for example, but not limitatively, a laundry washer. Reference numerals 105a and 105b denote two terminals which, in use, are plugged into an electricity main socket (not shown), for receiving the AC voltage (for example, terminal 105a is connected to a plug pin that is plugged to the AC socket port of the line voltage and terminal 105b is connected to a plug pin that is plugged to the AC socket port of the neutral); the AC voltage may for example be of 220V at 50 Hz nominal, or of 110V at 60 Hz nominal (other values are possible, depending on the standard adopted in a particular country).

The AC voltage is fed to a voltage transformer and rectifying circuit 110, for generating one or more DC voltage values, distributed by DC voltage distribution lines 115 and 120, for example a 5V voltage for supplying a logic control unit 125, including for example a microprocessor or a microcontroller, controlling the operation of the appliance. Either one or the other of the DC voltage distribution lines 115 and 120 may be connected to the neutral (terminal 105b).

Block 130 is intended to schematically represent all those parts of the appliance that are supplied by the AC voltage; such parts include for example the electric motor for rotating the laundry drum, the drain pump for discharging the washing/rinsing fluid, the electrovalve(s) for intaking water from a water main. The AC line voltage received at the terminal 105a is selectively fed to the parts schematized by block 130 through a main switch 135 (which may for example be the so-called “door-lock” switch), controlled by the control unit 125, which is closed only on condition that the appliance door (not depicted in the drawings) is correctly closed. In this way, it is ensured that, for safety purposes, the appliance cannot be started when the door is open, so as to prevent possible injuries. In alternative embodiments of the invention, some of the parts schematized as included in block 130 downstream the main switch 135 may be moved upstream it; this may for example be the case of the drain pump 137, shown in phantom in FIG. 1, which, when placed upstream the main switch 135, can be operated for safety purposes to discharge the liquid present in the machine even in case the door is open.

A heating circuit with monitoring arrangement 140 is provided, for heating the washing liquid for washing and/or rinse laundry. According to an embodiment of the present invention, the heating circuit 140 is connected to the AC voltage terminals 105a, 105b upstream the main switch 135, i.e. one terminal 145a of the hating circuit 140 is connected to a conductor connected to the terminal 105a and carrying the line voltage, and the other terminal 145b is connected to the neutral terminal 105b.

The operation of the heating circuit 140 is controlled by the control unit 125, which in addition monitors (through the monitoring arrangement) the heating circuit 140 for detecting possible faults, as will be described in greater detail in the following.

FIG. 2 provides a more detailed view of the heating circuit 140 according to an embodiment of the present invention. The heating circuit 140 of the exemplary embodiment here considered comprises at least one heating resistor 205, connected in series with two switches 210a and 210b (a high-side switch 210a and a low-side switch 210b) between the voltage line connected to line voltage terminal 105a and, respectively, the neutral line connected to neutral terminal 105b. The heating resistor 205 is the element that, when energized, heats the washing liquid and/or the drying air flow. The switches 210a and 210b are for example relays, particularly monostable or alternatively bistable relays, which controlled, similarly to the door-lock switch 135, by the control unit 140. One or two thermofuses may be provided at either one or both of the two terminals 215a and 215b of the heating resistor 205, for protecting the heating resistor 205 against burning in case of overheating (in such a case, one or both of the thermofuses blow and thereby disconnect the heating resistor from the heating circuit); however, as will result clear from the following, the provision of the thermofuses is not strictly necessary. A first resistor R1 is connected in shunt between the terminals 215a and 215b of the heating resistor 205 that are connected to the switches 210a and 210b, respectively; the first resistor R1 has a resistance value (e.g., approximately 150 KOhms) substantially higher than the typical resistance of the heating resistor 205 (thus, when the heating resistor 205 functions properly, the overall resistance of the shunt connection essentially coincides with the resistance of the heating resistor 205). A second resistor R2 is connected between terminal 215b and the voltage line downstream the main switch 135. The control unit 125 is arranged to sense the voltage at the terminal 215a through a voltage divider circuit comprising a third resistor R3 connected between terminal 215a and a measuring input 235 of the control unit 125, and a fourth resistor R4 connected between the measuring input 235 and one of the two DC voltage distribution lines 115 and 120, namely to the DC voltage distribution line that is connected to the neutral. The control unit 125 is further arranged to sense the line voltage received at terminal 105a, for example through a resistive voltage partition network which may include one or two resistors 245, 246 connected between the line voltage and the neutral.

The heating circuit arrangement described in the foregoing operates as follows.

When the appliance is plugged into the main voltage socket, the control unit 125 is energized.

When the user input an appliance start command, conditioned to the fact that the door is assessed to be closed, the control unit commands the main switch 135 to close, thereby energizing the machine parts schematized in block 130.

In order to heat the washing fluid and/or the drying air flow, the control unit 125 commands the switches 210a and 210b to close. In this way, the heating resistor 205 is energized. Also in this case, the control unit 125 commands the switches 210a and 210b to close only conditioned to the fact that the appliance door is assessed to be closed.

The control unit 125, thanks to the circuit arrangement shown, is able to monitor the correct operation of the heating circuit and to detect possible faults thereof. To do this, the control unit 125 may be configured (i.e. programmed) to perform a check sequence of the heating circuit for detecting possible failures of the components thereof.

The control unit 125 periodically senses the line voltage value via the voltage partition network 245, 246 (e.g., every 20-80 milliseconds).

From the sensed value of the line voltage, the control unit 125 dynamically calculates and periodically updates (e.g., every 20-80 milliseconds) threshold values; such threshold values are dimensionless quantities which are calculated using a mathematical function implemented by the control unit 125. Similarly, the control unit 125 derives, from the voltage received at the measuring input 235, a dimensionless quantity that is compared to the dimensionless threshold values calculated on the basis of the detected line voltage. Based on the outcome of the comparison, the control unit 125 is capable of detecting faults in the heating circuit arrangement. It is pointed out that the threshold values changes as the line voltage change: thanks to this, account is taken of the actual value of the line voltage, which as known may differ from country to country, and is also subject to fluctuations in time. This makes the detection of the possible fault conditions more accurate and reliable.

The table below (Table 1) provides an indication of how the voltage sensed at the measuring input 235, and thus the dimensionless value calculated by the control unit 125, changes depending on the status of the heating circuit arrangement and in case of different fault conditions. The values in Table 1 shown underlined are indicative of fault conditions.

TABLE 1

| Door | Switch | Switch | | | | | | |
|---|---|---|---|---|---|---|---|---|
| lock | 210a | 210b | Sensed value | | | | | |
| open | open | open | 0 | 0 | 0 | 0 | 0 | 202 |
| closed | open | open | 170 | <150 | <170 | 3 | <170 | 202 |
| closed | open | closed | 3 | 0 | <170 | 3 | 3 | 202 |
| closed | closed | closed | 202 | 202 | 202 | 202 | 3 | 202 |
| | | | No | heating | Switch 210b glued open OR | Switch 210b | Switch 210a glued open or | Switch 210a glued close |
| | | | faults | resistor open | fault of driving circuit | glued close | fault of driving circuit | |

When the control unit 125 commands the main switch 135 and the other two switches 210a and 210b to be in the open condition (first row of Table 1), the voltage sensed by the control unit 125 at the input 235 should (in case of no faults) be low, close to earth (the third and fourth resistors R3 and R4 pull the terminal 215a to ground); in Table 1, the dimensionless value corresponding to an absence of faults is 0. A detected high value (corresponding to the value of the line voltage) of the voltage at the input 235 (and thus a high value of the dimensionless value derived therefrom) is thus indicative of the fact that the switch 210a does not operate properly and is blocked close (“glued close”).

When the control unit 125 commands the door lock switch 135 to close, but keeping the other two switches 210a and 210b open, so as to keep the heating resistor 205 de-energized (second row in Table 1), the voltage sensed at the input 235 should, in case of no faults, be relatively high but less than the value of the line voltage: in fact, in this condition a resistive path should exist that, from the line connected to the line voltage terminal 105a, passes through the main switch 135, the second resistor R2, the shunt of the heating resistor 205 and the first resistor R1, the third resistor R3, the fourth resistor R4 and reaches the neutral. In Table 1, the dimensionless value corresponding to no faults is 170. As shown in Table 1, based on the value of the voltage sensed at the input 235, the control unit 125 is capable of detecting and discriminating three possible faults:

a) a relatively high value (150 or less in Table 1), but sufficiently lower than the value (170) corresponding to the no-fault condition is indicative of the fact that the heating resistor 205 is “open”, i.e. non-conductive; in fact, in this case the resistance value of the shunt connection between the heating resistor 205 and the first resistor R1 essentially coincides with the resistance of the first resistor R1, which is substantially higher than the resistance of the heating resistor 205. This type of fault may depend on a malfunctioning of one or both of the thermofuses which may be provided at the terminals of the heating resistor 205, or a problem of the heating resistor 205.

b) a very low value (3 in Table 1), close to ground, is indicative of the fact that the switch 210b is blocked closed (“glued close”); in fact, in this condition the terminal 215b is short-circuit to the neutral, and thus the voltage at the terminal 215a is low.

c) a high vale, corresponding to the line voltage (202 in Table 1) is indicative of the fact that the switch 210a is blocked close (“glued close”); in fact, in this condition the terminal 215a is short-circuited to the line voltage.

When the control unit 125 commands the main switch 135 to close, the switch 210a to open and the switch 210b to close (third row in Table 1), a no-fault condition correspond to a very low value sensed at the input 235 (corresponding to the dimensionless value 3 in Table 1); indeed, in this condition the terminal 215b is short-circuit to the neutral, and thus the voltage at the terminal 215a is low. As shown in Table 1, based on the value of the voltage sensed at the input 235, the control unit 125 is capable of detecting and discriminating two possible faults:

d) a first high voltage value (170 or less as indicated in Table 1) means that the switch 210b is “glued open”, or that there is a fault in the driving output of the control unit that drives the switch 210b.

e) a second high vale, higher than the first high value and corresponding to the line voltage (202 in Table 1) is indicative of the fact that the switch 210a is blocked close (“glued close”); in fact, in this condition the terminal 215a is short-circuited to the line voltage.

When, finally, the control unit 125 commands all the switches 135, 210a and 210b to close (fourth row in Table 1), a no-fault condition corresponds to a high voltage value sensed at the input 235; in fact, in this condition the terminal 215a should be short-circuit to the line voltage. A very low value (close to ground) is in this case indicative of the fact that the switch 210a is “glued open” (or that there is a fault in the driving output of the control unit that drives the switch 210a. In fact, in this condition the terminal 215b is short-circuit to the neutral, and thus the voltage at the terminal 215a is low.

The provision of the two switches 210a and 210b in the heating circuit 140, one upstream and the other downstream the heating resistor 205, makes the heating circuit 140 safer: also in case of faults in the heating resistor, by switching open the two switches 210a and 210b the appliance can be put in conditions of safety for the user without having to open the door, and possibly without having to halt the machine operation.

In particular, the heating circuit described allows to discriminate whether a fault consists in the heating resistor being disconnected or in current leakages in the heating resistor; the first fault is not dangerous for the user's safety: it simply means that the washing liquid (or the drying air flow) cannot be heated; the second fault is instead potentially dangerous, because of dispersion currents. In both cases, the machine cycle needs not be halted: the control unit 125 commands the two switches 210a and 210b to open and leaves the appliance to terminate the cycle.

Thus, thanks to the circuit arrangement according to the described embodiment, it is possible to detect not only a failure of the heating resistor 205 consisting in a short-circuit to the neutral, but also to detect if a failure involving the heating resistor is risky or acceptable.

An advantage of the described solution is that the heating circuit, inclusive the elements necessary to properly monitor the heating circuit for possible faults, substantially does not involve stand-by power consumption. In fact, when the appliance is not operating, the main switch 135 and the two switches 210a and 210b are open, thus no conductive path exists between the line voltage and the neutral (also the resistive path including resistors R2, R1 in parallel to 205, R3 and R4 is disconnected from the line voltage); the only consumption is given by the resistive partition network 245, 246. However, nothing prevents from connecting the second resistor R2 upstream the main switch 135, or, viceversa, connecting the heating circuit (heating resistor 205 and switches 210a and 210b) downstream the main switch 135 and the second resistor R2 upstream, or moving all circuit 140 downstream the main switch 135.

Clearly, those skilled in the art will be able to make several changes to the described invention embodiment, without departing from the scope of the invention defined in the appended claims.

For example, the second resistor R2 may be connected to the terminal 215a of the heating resistor 205, and the measuring input 235 of the control unit 125 may be coupled to the terminal 215b.

1. A washing and/or drying appliance, comprising a heating circuit for heating a washing liquid and/or a drying air flow, the heating circuit being connected to voltage distribution lines distributing power inside the appliance and comprising at least one heating resistor in series to switch means controlled by an appliance control unit for selectively energizing the heating resistor when required, wherein:
the switch means of the heating circuit comprise a first switch and a second switch in series to the heating resistor, the heating resistor being interposed between the first and second switches; and
a monitoring circuit arrangement is provided, said monitoring circuit arrangement comprising a first resistor in shunt to the heating resistor and having a resistance substantially higher than that of the heating resistor, and a pull-up network connected between a first terminal of the heating resistor and one of the voltage distribution lines, the control unit being configured for receiving a voltage corresponding to an electric potential at a second terminal of the heating resistor.

2. The appliance of claim 1, further comprising a main switch controlled by the control unit for selectively allowing the powering of the appliance, wherein the heating circuit is connected to the voltage supply lines upstream or downstream of the main switch with respect to an AC voltage plug of the appliance.

3. The appliance of claim 2, wherein said main switch is switchable to close only conditioned to the fact that the control unit detects that an appliance door is closed.

4. The appliance of claim 2, wherein said pull-up network is connected to said voltage distribution lines either downstream or upstream the main switch.

5. The appliance of claim 1, wherein the monitoring unit is further configured for detecting a value of the voltage distributed by the voltage distribution lines and for comparing the detected value of the voltage distributed by the voltage distribution lines with the received voltage corresponding to the electric potential at the second terminal of the heating resistor.

6. The appliance according to claim 5, in which the monitoring unit is configured for dynamically deriving, during the operation of the appliance, from the detected value of the voltage distributed by the voltage distribution lines, at least one reference electric potential to be compared with the received voltage corresponding to the electric potential at the second terminal of the heating resistor.

7. The appliance according to claim 6, in which said reference electric potential derived in a dynamic way is calculated periodically.

8. The appliance of claim 3, wherein said pull-up network is connected to said voltage distribution lines either downstream or upstream the main switch.

9. The appliance of claim 2, wherein the monitoring unit is further configured for detecting a value of the voltage distributed by the voltage distribution lines and for comparing the detected value of the voltage distributed by the voltage distribution lines with the received voltage corresponding to the electric potential at the second terminal of the heating resistor.

10. The appliance of claim 3, wherein the monitoring unit is further configured for detecting a value of the voltage distributed by the voltage distribution lines and for comparing the detected value of the voltage distributed by the voltage distribution lines with the received voltage corresponding to the electric potential at the second terminal of the heating resistor.

11. The appliance of claim 4, wherein the monitoring unit is further configured for detecting a value of the voltage distributed by the voltage distribution lines and for comparing the detected value of the voltage distributed by the voltage distribution lines with the received voltage corresponding to the electric potential at the second terminal of the heating resistor.

12. The appliance of claim 8, wherein the monitoring unit is further configured for detecting a value of the voltage distributed by the voltage distribution lines and for comparing the detected value of the voltage distributed by the voltage distribution lines with the received voltage corresponding to the electric potential at the second terminal of the heating resistor.
